(19) United States
(12) Patent Application Publication
(10) Pub. No.: US 2022/0342949 A1
(43) Pub. Date: Oct. 27, 2022

(54) METHODS, MEDIA, AND SYSTEMS FOR ENHANCING A WEB BROWSING SESSION

(71) Applicant: Capital One Services, LLC, McLean, VA (US)

(72) Inventors: Elizabeth FURLAN, Plano, TX (US); Steven DANG, Plano, TX (US); Chih-Hsiang CHOW, Plano, TX (US)

(73) Assignee: Capital One Services, LLC, McLean, VA (US)

(21) Appl. No.: 17/240,084

(22) Filed: Apr. 26, 2021

(51) Int. Cl. G06F 16/9535; G06Q 30/02

(52) U.S. Cl. CPC G06F 16/9535; G06Q 30/0255

(57) ABSTRACT

Methods, media and systems are provided for enhancing a web browsing session. Methods and media include retrieving a user profile containing information related to a potential vehicle buyer or a vehicle profile containing information related to a vehicle of interest. Historical use data of a web browser associated with the corresponding user profile is retrieved. Enhancing the web browsing session further includes analyzing an input received from a current web browser session associated with the user profile or vehicle profile and determining a vehicle characteristic related to the analyzed input. An automated phrase corresponding to the vehicle characteristic is selected to elicit further user interaction during the current web browser session. The selected automated phrase is based on the determined vehicle characteristic. Systems include a profile database for storing user/vehicle profiles and a memory storing a set of computer-executable instructions to enhance a web browsing session.

### TECHNICAL FIELD

The following application relates to methods, media and systems for enhancing web browsing sessions through selection of automated phrases to elicit further user interaction during the web browsing session.

### BACKGROUND

As more transactions move online, an increasing emphasis has been placed on enhancing the web browsing experience for users. To enhance a web browsing session, a website may be updated to a more user-friendly version, relevant product information may be provided to a potential customer browsing the website, or additional links with material related to what the user is currently viewing may be automatically recommended, among other enhancements. One objective of these enhancements is keeping the user actively engaged in the web browsing experience.

In an effort to present these enhancements to the user in a manner that is as minimally invasive as possible (e.g., requires the least effort or alters the experience as little as possible), many websites have turned to aggregating user data through a variety of passive tracking techniques. Passively tracking the web browsing activity of users allows potentially valuable insight into the interests of those users. After the insight has been gleaned, the website may tailor the overall web browsing experience to that specific user.

Accordingly, systems, methods and media for enhancing web browsing experiences by eliciting further user interaction during a web browser session are needed.

### SUMMARY

In certain aspects of the disclosed embodiments, a method of enhancing a web browsing session is provided. The method includes retrieving one of a user profile containing information related to a potential vehicle buyer or a vehicle profile containing information related to a vehicle of interest. The method also includes retrieving historical use data of a web browser associated with the corresponding user profile or vehicle profile. The method further includes analyzing an input received from a current web browser session. The method includes determining a vehicle characteristic related to the input; and selecting, based on the vehicle characteristic, an automated phrase corresponding to the vehicle characteristic. The automated phrase is selected to elicit further user interaction during the current web browser session.

In some aspects of the disclosed embodiments, the method further includes transmitting the selected automated phrase for presentation in the current web browsing session. In other aspects of the disclosed embodiments, the method includes retrieving the historical use data includes retrieving browser cookies storing browsing history and the user profile or the vehicle profile.

In some aspects of the disclosed embodiments, the method includes selecting the automated phrase by performing, by an artificial intelligence agent, an algorithmic comparison of previous searches, browsing actions, and purchase history to identify a phrase having a highest probability of eliciting a further user interaction. In certain aspects of the disclosed embodiments, the algorithmic comparison uses a distributive algorithm to identify the phrase having a highest probability of eliciting further user interaction. In some aspects of the disclosed embodiments, selecting the automated phrase includes selecting one of a phrase offering to provide additional information about the vehicle characteristic, a phrase providing additional information about the vehicle characteristic, or a phrase requesting additional information from the user related to the vehicle characteristic. In certain aspects of the disclosed embodiments, selecting the automated phrase in the method also includes selecting a phrase further explaining dealer practices, financing options for the vehicle of interest, a preferred loan package for the vehicle of interest, a prequalified loan package for the vehicle of interest, fees, trade-in options, pricing options, vehicle comparisons, alternate vehicles, or alternate vehicle dealerships.

In some aspects of the disclosed embodiments, analyzing the input in the method includes analyzing one or more of a keystroke, a mouse movement, a user interface gesture, a user device movement, device location information, a browser selection, a browser operation, a user voice command, an eye-gaze measurement, or a biometric measurement.

In certain aspects of the disclosed embodiments, a system for presenting interactive phrases in a web browsing session is provided. The system includes a profile database configured to store user profiles related to potential vehicle buyers and vehicle profiles related to vehicles available for purchase. The system also includes a memory configured to store a set of computer-executable instructions that when executed include a browser interface, an input analyzer, and a phrase selection engine. The browser interface is configured to communicate with the profile database, send at least portions of the vehicle profiles to a web browser, and receive inputs associated with respective user profiles or vehicle profiles. The input analyzer is configured to receive the inputs from the browser interface and determine vehicle characteristic related to the inputs. The phrase selection engine is configured to select, based on the vehicle characteristics, automated phrases corresponding to the vehicle characteristics. The automated phrases are selected for transmission by the browser interface to the web browser, where the automated phrases are selected to elicit further user interaction. The system further includes one or more processors configured to execute the set of computer-executable instructions.

In some aspects of the disclosed embodiments, the phrase selection engine of the system is an artificial intelligence agent configured to select an automated phrase by performing an algorithmic comparison of previous searches, browsing actions, and purchase history to identify a phrase having a highest probability of eliciting further user interaction. In some aspects of the disclosed embodiments, the phrase selection engine is configured to use a distributive algorithm to identify the phrase having the highest probability of eliciting further user interaction. In certain aspects of the disclosed embodiments, the phrase selection engine is configured to select one of a phrase offering to provide additional information about the vehicle characteristic, a phrase providing additional information about the vehicle characteristic, or a phrase requesting additional information from a user related to the vehicle characteristic.

In some aspects of the disclosed embodiments, the input analyzer is configured analyze one or more of a keystroke, a mouse movement, a user interface gesture, a user device movement, device location information, a browser selection, a browser operation, a user voice command, an eye-gaze measurement, or a biometric measurement. In some other aspects of the disclosed embodiments, the phrase selection engine is further configured to select a phrase further explaining dealer practices, financing options for the vehicle of interest, a preferred loan package for the vehicle of interest, a prequalified loan package for the vehicle of interest, fees, trade-in options, pricing options, vehicle comparisons, alternate vehicles, or alternate vehicle dealerships.

In certain aspects of the disclosed embodiments, a non-transitory computer-readable medium is provided that stores instructions that, when executed by one or more processors of a device, cause the one or more processors to perform a method of enhancing a web browsing session. The instructions stored on the non-transitory computer-readable medium include instructions for retrieving one of a user profile containing information related to a potential vehicle buyer or a vehicle profile containing information related to a vehicle of interest. The instructions stored on the non-transitory computer-readable medium also include instructions for retrieving historical use data of a web browser associated with the corresponding user profile or vehicle profile. The instructions stored on the non-transitory computer-readable medium include instructions for analyzing an input received from a current web browser session associated with the historical use data and the user profile or vehicle profile. The instructions stored on the non-transitory computer-readable medium further include instructions for determining a vehicle characteristic related to the input. The instructions stored on the non-transitory computer-readable medium further include instructions for selecting an automated phrase corresponding to the vehicle characteristic based on the determined characteristic. The automated phrase is selected to elicit further user interaction.

In some aspects of the disclosed embodiments, the instructions stored on the non-transitory computer-readable medium include instructions for transmitting the selected automated phrase for presentation in the current web browsing session. In other aspects of the disclosed embodiments, the instructions stored on the non-transitory computer-readable medium include instructions for retrieving the historical use data includes retrieving browser cookies storing browsing history and the user profile or the vehicle profile. In some aspects of the disclosed embodiments, the instructions stored on the non-transitory computer-readable medium further include instructions for selecting the automated phrase comprises performing, by an artificial intelligence agent, an algorithmic comparison by a distributive algorithm of previous searches, browsing actions, and purchase history to identify a phrase having a highest probability of eliciting further user interaction.

In some aspects of the disclosed embodiments, the instructions stored on the non-transitory computer-readable medium include instructions for analyzing the input comprises analyzing one or more of a keystroke, a mouse movement, a user interface gesture, a user device movement, device location information, a browser selection, a browser operation, a user voice command, an eye-gaze measurement, or a biometric measurement. In other aspects of the disclosed embodiments, the instructions stored on the non-transitory computer-readable medium include instructions for selecting the automated phrase comprises selecting one of a phrase offering to provide additional information about the vehicle characteristic, a phrase providing additional information about the vehicle characteristic, or a phrase requesting additional information from the user related to the vehicle characteristic, wherein the additional information explains dealer practices, financing options for the vehicle of interest, a preferred loan package for the vehicle of interest, a prequalified loan package for the vehicle of interest, fees, trade-in options, pricing options, vehicle comparisons, alternate vehicles, or alternate vehicle dealerships.

### BRIEF DESCRIPTION OF THE DRAWINGS

Descriptions are given with reference to the figures included herein. When possible and for clarity, reference numbers are kept consistent from figure to figure. Some of the figures are simplified diagrams, which are not to be interpreted as drawn to scale or spatially limiting for the described embodiments. Where appropriate, the particular perspective or orientation of a figure will be given to increase understanding of the depicted features.

FIG. 1 is a block diagram of a system for presenting interactive phrases in a web browsing session, according to embodiments of the present disclosure;

FIG. 2 is a flow chart describing a method of enhancing a web browsing session, according to embodiments of the present disclosure;

FIG. 3 is a depiction of a browser interface, according to embodiments of the present disclosure; and

FIG. 4 is an example computer system, according to an embodiment of the present disclosure.

### DETAILED DESCRIPTION

Systems, media, and methods for presenting interactive phrases in a web browsing session are described in detail below. The interactive phrases may be designed to elicit further interaction from users (e.g., a person browsing a particular website) or to otherwise enhance the web browsing experience of the user. Various artificial intelligence and machine learning algorithms may be used in determining a phrase having the highest probability of eliciting a further interaction from the user to maintain interactivity/engagement with the website being browsed. The algorithms may analyze the browsing history of the user, the inputs made by the user during an active browsing session, cookies, session IDs, or other tracking/data aggregation means, or a combination thereof, to determine the interactive phrase having the highest probability of eliciting further user interaction.

In a non-limiting example, the aggregation of user data to enhance the web browsing experience of a user can include the implementation of chatbots. Chatbots may offer assistance to a user while browsing a website. However, in some prior approaches chatbots were somewhat generic, intrusive, or less than helpful. Often times the conventional chatbot attempts to elicit interaction from the user with a question, such as “How can I help you?” In the event the user does not dismiss the chatbot, the user may be prompted to provide a response to the question. Any response can lead to a keyword match, but may also result in misrouting the response to an irrelevant address or sending the user back to a previously presented resource, such as a frequently asked questions (FAQs) page.

The interactive phrases presented to the user in the present application are intended to extend the time the user spends actively engaging with the web site and to enhance the web browsing experience for the user. The enhanced web browsing experience may further encourage the user to actively engage with the web site and may increase the chances the user returns to the website in the future. Interactive phrases presented to the user may enhance the web browsing experience by, for example, providing the user with additional information about the products/articles being viewed in the current browsing session or that the artificial intelligence has determined to be of interest to the user based on an analysis of at least a portion of the browsing history of the user. Interactive phrases presented to the user may also provide alternative information sources or buying options to the user and/or otherwise tailor the browsing experience to the preferences of the user.

While shown in the singular and with simplified terms in the figures and below, one of skill in the relevant art will recognize that implementation of the described embodiments can take many forms. Thus, a single device depicted in the figures or described below may represent several, dozens or hundreds of the devices disclosed. The particular arrangement is likewise not a limiting factor with respect to the scope of the present application. Steps may be performed in a different order, while communications may be carried out directly or indirectly with various devices performing intermediary functions between those described devices.

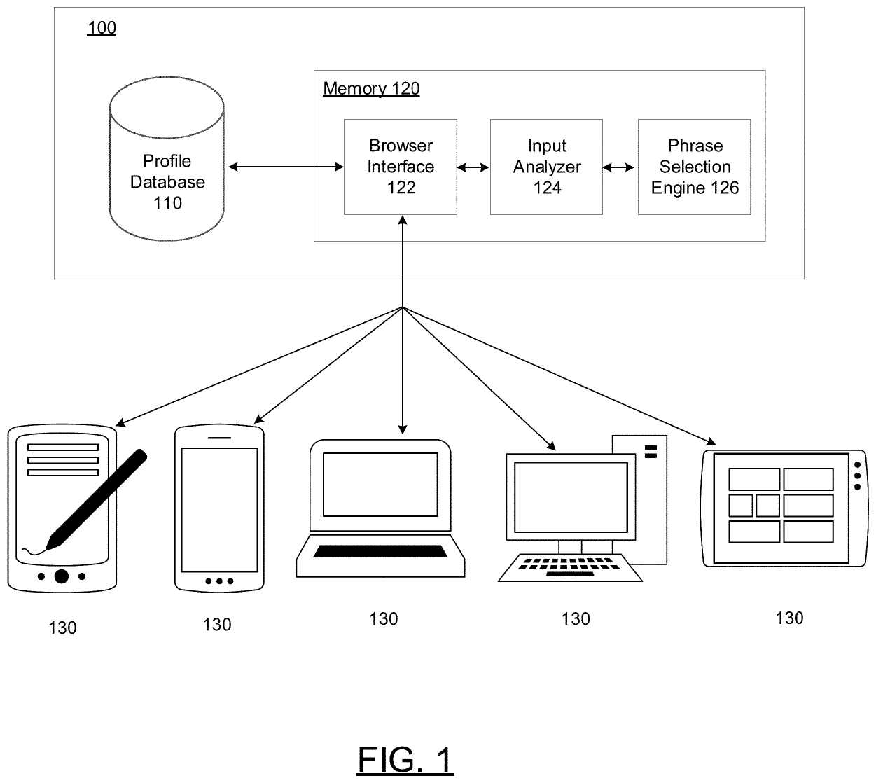

FIG. 1 is a block diagram of a system 100 for presenting interactive phrases in a web browsing session. The system 100 includes a profile database 110 and a memory 120. The database 110 and various applications and/or instructions residing in memory may be executed by one or more processors (not shown). The system 100 may be configured to communicate with any number/type of computing device provided sufficient infrastructure is included in the system 100. Some of the devices with which the system 100 may configured to communicate include a personal digital assistant (PDA), a mobile phone, a laptop, a personal computer (PC), and/or a tablet-style computing device.

More specifically, and as illustrated in FIG. 1, the system 100 is shown as capable of communicating with a web browser running on computing devices 130 via a browser interface 122 included in the memory 120. The memory 120 can also include an input analyzer 124 and a phrase selection engine 126. The computing resources or infrastructure supporting/hosting the subcomponents of the system 100 (e.g., the profile database 110, the memory 120, the browser interface 122, the input analyzer 124, and the phrase selection engine 126) may include a combination of computing clusters, servers, databases, and applications. According to the present disclosure, the computing infrastructure may be entirely cloud-based, entirely non-cloud-based (e.g., locally hosted), or a combination thereof. Although the computing infrastructure underlying the subcomponents of the system 100 above and below may be either explicitly or implicitly referred to as “cloud-based”, it is to be understood that any discussion of such infrastructure applies equally to locally based and mixed implementations.

According to the present disclosure, system 100 may be configured to communicate with computing devices running a number of different operating systems. System 100 may be configured to communicate with computing devices running a variety of operating systems. For instance, system 100 may be configurable to communicate with mobile terminals running either IOS™ (available from Apple, Inc., of Cupertino, Calif.) or ANDROID™ (produced by Alphabet, Inc. of Mountain View, Calif.) operating systems, as well as laptops/personal computers running MACOS™ (from Apple), WINDOWS™ (a product of Microsoft Corp. of Renton, Wash.), or one of many Linux variants. Examples of the web browser running on computing devices 130 communicating with system 100 via browser interface 122 may include GOOGLE CHROME™ (from Alphabet), SAFARI™ (from Apple), FIREFOX™ (available from Mozilla Corp. of Mountain View, Calif.), and INTERNET EXPLORER™ (from Microsoft). Provided system 100 is configured to communicate with the operating system running on computing device 130, system 100 may communicate with any web browser running on any device.

A web browsing session, as may be hosted by the web browser on computing device 130, typically includes a visitor (or user) of an individual website interacting with the website over a certain period of time. To interact with the website, the user may supply a series of user inputs. The series of user inputs, supplied by the user to invoke a desired response from the website, may include a combination of keystrokes, mouse inputs (e.g., pointing, clicking, selecting, or scrolling), gestures/touch operations, voice commands, and the like. For instance, the user may input, via a keyboard, a string of text (e.g., “cars”) into a search engine to research the same. As another example, using a mouse or other pointing device, the user may click, scroll, or execute drag-and-drop operations to add items to a virtual shopping cart. Alternatively, the user can speak certain words/phrases to activate a personal digital assistant capable of performing a voice-activated search on “cars” and/or purchasing various items for the user.

To track web browsing sessions, a session ID may be stored in a web browser (e.g., the web browser on computing device 130) of the visitor. The session ID, in combination with any Hypertext Transport Protocol (HTTP) requests (e.g., clicking a link) made by the user while browsing the website, may be logged. The term “session”, as used above and below, may refer to the time the user spends browsing a website and is intended to represent the time between the user first arriving at the website and the time the user stops using or leaves the website.

To further track web browsing sessions, a cookie may be stored in the browser of the user. Typically, a cookie anonymously identifies a specific user of a website and/or a specific computing device using the website. Cookies may be used for authentication purposes, storing site preferences, and saving shopping carts/server session identification information.

The information captured by session IDs and cookies allow developers to customize pages to create a web browsing experience that is personalized to an individual user and more engaging. For instance, cookies may store information related to a name and other personal information of the user. The data may have been collected while the user was filling out a form (e.g., a loan application). While filling out a subsequent loan application, the personal information stored in the cookie may automatically populate into the corresponding fields of the subsequent application. Moreover, information collected from completing the first loan application in a first browsing session may be available to automatically populate into various other websites and/or other forms visited by the user in the future across different browsing sessions.

The profile database 110 may be configured to store user profiles related to potential vehicle buyers and vehicle profiles related to vehicles available for purchase. According to the present disclosure, user profiles stored on the profile database 110 may include personal information of the user. Examples of the user's information that may be stored in the user profile include first and last name, address, email address, phone number, various identification numbers, and/or the like. Vehicle profiles stored on the profile database 110 may include vehicle characteristics that are of interest to the user. Examples of vehicle characteristics that may be stored vehicle profiles may include a vehicle identification number (VIN), make, model, year, mileage, trim level or package, and the like.

Memory 120 may be a memory device (e.g., a hard drive, a solid-state drive, RAM, ROM, PROM, flash memory, etc.), or a combination thereof, configured to store a set of computer-executable instructions that when executed by the one or more processors included in system 100 present the interactive phrases in the web browsing session. Memory 120 may be included in, or include, a database, server, computing cluster, or other computing infrastructure for implementing system 100. Alternatively, some portions of memory 120 may be included in the computing device running the web browser on computing device 130.

Memory 120 is shown as being in two-way communication with profile database 110 and the web browser on computing device 130 via browser interface 122. Communications between memory 120, profile database 110, and the web browser on computing device 130 may be allowed via a combination of communications protocols including WiFi, WiMax, Bluetooth, 2G, 3G, 4G, 5G, Long Term Evolution (LTE), Radio-Frequency Identification (RFID), Near-Field Communication (NFC), Hypertext Transport Protocol (HTTP), Internet Protocol (IP), or Transmission Control Protocol (TCP) among others, or a combination thereof.

In many embodiments, browser interface 122 may be configured to communicate with profile database 110, send at least portions of user or vehicle profiles stored in profile database 110 to the web browser on computing device 130, and receive inputs associated with the respective user profiles or vehicle profiles. Inputs associated with the user/vehicle profiles may be received by computing device 130 running the web browser. These inputs may express a customer's emotions in response to various situations. Emotions can be positive and negative, often influenced by one's interests, personality, mood and temperament.

Input analyzer 124 may be configured to receive the inputs from the web browser on computing device 130 via browser interface 122 and determine vehicle characteristics related to the inputs. Input analyzer 124 may include an assortment of cloud-based and locally hosted computing infrastructure elements enabling system 100 to analyze the inputs of a user of the web browser on computing device 130. Input analyzer 124 may be configured to analyze one or more of a keystroke, a mouse movement, a user interface gesture, a user device movement, device location information, a browser selection, a browser operation, a voice command, an eye-gaze measurement, or a biometric measurement (e.g., a pulse, a fingerprint, a retina scan, etc.). A variety of artificial intelligence or machine learning algorithms may be used to analyze or otherwise process the user inputs.

An initial overview of artificial intelligence/machine learning is first provided immediately below and then specific exemplary embodiments of systems and methods for verifying a user identity are described in further detail. The initial overview is intended to aid in understanding some of the technology relevant to the systems and methods disclosed herein, but it is not intended to limit the scope of the claimed subject matter.

In the world of machine prediction, there are two subfields—knowledge-based systems and machine learning systems. Knowledge-based approaches rely on the creation of a heuristic or rule-base which is then systematically applied to a particular problem or dataset. Knowledge-based systems make inferences or decisions based on an explicit “if-then.” rule system. Such systems rely on extracting a high degree of knowledge about a limited category in order to virtually render all possible solutions to a given problem. These solutions are then written as a series of instructions to be sequentially followed by a machine.

Machine learning, unlike the knowledge-based programming, provides machines with the ability to learn through data input without being explicitly programmed with rules. For example, as just discussed, conventional knowledge-based programming relies on manually writing algorithms (i.e. rules) and programming instructions to sequentially execute the algorithms. Machine learning systems, on the other hand, avoid following strict sequential programming instructions by making data-driven decisions to construct their own rules. The nature of machine learning is the iterative process of using rules, and creating new ones, to identify unknown relationships to better generalize and handle non-linear problems with incomplete input data sets.

Examples of machine learning techniques include, but are not limited to decision tree learning, association rule learning, inductive logic programming, support vector machines, clustering, Bayesian networking, reinforcement learning, representation learning, similarity and metric learning, spare dictionary learning, rule-based machine learning, and artificial neural networks.

One such machine learning technique involves the use of “artificial neural networks.” Artificial neural networks are computational systems that allow computers to essentially function in a manner analogous to that of the human brain. Generally, a neural network is an information-processing network and an artificial neural network is an information-processing network inspired by biological neural systems. Artificial neural networks create non-linear connections between computation elements (i.e., “nodes” and “clusters”) operating in parallel and arranged in patterns. The nodes are connected via variable weights, typically adopted during use, to improve performance. Thus, in solving a problem or making a prediction, an artificial neural network model can explore many hypotheses and permutations by simultaneously using massively parallel networks composed of many computational elements connected by links with variable weights.

The function of the artificial neural network is determined by the network structure, connection strengths, and the processing performed at the computation elements. The nodes can be “neuron-like” computational elements that output a signal based on the sum of their inputs, the output being the result of an activation function. Much like a biological neural network, an artificial neural network thus has a plurality of computation elements interconnected with weighted communication bridges. By adjusting the weight values of the connections between computation elements in a network, one can match certain inputs with desired outputs. The respective weights assigned to particular computation elements are dynamic and can be modified in response to training. Through this weighted connection structure, the network “communicates,” identifies unknown relationships, and “learns” the characteristics of general input categories. Thus artificial neural networks do not require pre-programming that anticipates all possible variants of the input data they receive.

As already discussed, a neural network is not programmed; instead, it is “taught.” Of course, there are many variations for teaching an artificial neural network. Some networks are taught through examples, whereas others extract information directly from the input data. The two variations are called “supervised” and “unsupervised” learning. In supervised systems, a learning algorithm is incorporated to adjust the weights of the connections in the network for optimal performance, based on the presentation of a predetermined set of correct stimulus-response pairs. Rather than attempting to anticipate every possible exhibition of data, artificial neural networks attempt to recognize patterns of data and make decisions based on the conformity with historical patterns having known attributes. The training of neural networks involves an iterative process where individual weights between nodes are repeatedly adjusted until the system converges to produce a derived output. While training a neural network may be time consuming, it is not labor intensive and avoids the necessity to develop an explicit algorithm. In essence, after training, the architecture of the neural network embodies the algorithm. The techniques and algorithms for training neural networks are numerous and diverse, each having certain advantages and disadvantages.

In contrast to supervised systems, unsupervised systems require no historical training data to train the system. The artificial neural network is autonomous and as such it can automatically determine properties about data and reflect these properties in an output. Unsupervised neural networks take into consideration not only the properties of individual events producing data, but the event's relationship with other events and the event's relationship to predetermined concepts which characterize the event collection. One unsupervised learning technique, conjunctive conceptual clustering, was first developed in the early eighties by Stepp and Michalski. A detailed explanation of the technique is disclosed in their article; Michalski, R. S.; Stepp, R. E. “Learning from Observation: Conceptual Clustering”, Chapter 11 of Machine Learning: an Artificial Intelligence Approach, eds. R. S. Michalski, J. G. Carbonell and T. M. Mitchell, San Mateo: Morgan Kaufmann, 1983.

In many embodiments, the system 100 may be implemented with modules and sub-modules. For example, the system 100 may include an input analyzer 124 that is configured with any of the machine learning/artificial intelligence systems described above or known to those skilled in the art. How the machine learning model operates will be described further below. The inputs may include a combination of keystrokes, mouse inputs (e.g., pointing, clicking, selecting, or scrolling), gestures/touch operations, voice commands, variables, parameters, conditional statements, or a combination thereof.

As indicated, the training can be done via supervised training methods. Supervised training methods refer to machine learning tasks where machines can be taught to map an input to an output based on example input-output pairs. In many embodiments, the supervised training can proceed by feeding the neural networks various input patterns of application specific inputs, and attempting to match these input patterns to templates. Based on how the neural networks match the input patterns to the templates, the neural networks can be given feedback. In many embodiments, this process can be performed over a period of time, to train the neural networks to recognize which input patterns match to what templates. As a part of the training process, weights and biases connecting the linear layers of the neural network can be tuned based on the feedback. The weights and biases are values that provide multipliers for the computations performed by the neural networks to give greater or lesser weight to certain outcomes of computations of the neural network. The tuning of the weights and biases allows the neural networks to better map future input patterns for similar functions to the templates implementing those functions.

Phrase selection engine 126 may be configured to select automated phrases corresponding to the vehicle characteristics based on the determined vehicle characteristics. In accordance with the present disclosure, the automated phrases selected for transmission by browser interface 122 to the web browser of computing device 130 may be selected to elicit further user interaction. In some examples, phrases generated by phrase selection 126 may be presented via the web browser of computing device 130 as a pop-up dialogue or chat box.

Browser interface 122 may allow the user to input data or receive inputs made by the user through the web browser on computing device 130 corresponding to fields of information included in a user profile and/or a vehicle profile. Inputs associated with the respective user profiles or vehicle profiles may be received via any combination of interface devices such as a keyboard, a mouse, a touch-sensitive display device, a trackpad, a signature pad, and the like.

The one or more processors included in system 100 may be configured to execute the set of computer-executable instructions stored on memory 120. In some examples, the processors may be included in the computing device. In other examples, the processors may be included in additional infrastructure included in system 100. In still other examples, the processors executing the computer-executable instructions may be included in the computing device and/or elsewhere throughout system 100.

In some embodiments, phrase selection engine 126 may be an artificial intelligence agent configured to select an automated phrase by performing an algorithmic comparison of previous searches, browsing actions, and purchase history to identify a phrase having a highest probability of eliciting a further user interaction. In many embodiments, phrase selection engine 126 may be configured to use a distributive algorithm to identify the phrase having the highest probability of eliciting a further user interaction. The further user interaction elicited by the phrase selection 126 may include a combination of a keystroke, a mouse movement/input, a user interface gesture, a user device movement, a voice command, an eye-gaze measurement, a biometric measurement, a browser selection/operation, and/or any of the aforementioned user interactions/inputs.

In various embodiments, phrase selection engine 126 may select a phrase offering to provide additional information about the vehicle characteristic, a phrase providing additional information about the vehicle characteristic and/or a phrase requesting additional information from a user related to the vehicle characteristic. Phrase selection engine 126 may be further configured to select a phrase further explaining dealer practices, financing options for the vehicle of interest, a preferred loan package for the vehicle of interest, a prequalified loan package for the vehicle of interest, fees (e.g., loan origination fees), trade-in options, pricing options, vehicle comparisons, alternate vehicles, or alternate vehicle dealerships.

As a non-limiting example, a user can be in the process of conducting research in preparation of buying a used car. The user may have conducted a number of searches on vehicle makes and models, features, etc. over a period of time. After that research, the user is interested in an electric vehicle (EV). The user may have preferences as to color of the vehicle, an earliest or latest model year, additional technical specifications, a maximum accumulated mileage, and a maximum cost. Throughout the course of conducting research, the user determined a preferred car dealership at which to complete the transaction, although the user may recognize that inventory of EVs may be limited. Therefore, the user has also indicated a willingness to travel anywhere within a 50-mile radius to acquire the car. Finally, after settling on financing the purchase, the user comparison-shopped auto loans at a number of local lenders (e.g., banks, credit unions, etc.).

If using a system that is substantially similar or identical to system 100, the user can begin the process of indicating preferred vehicle characteristics through a series of user inputs via web interface 122 by way of the web browser on computing device 130 (e.g., the mobile application and/or website of the car buying service running on the computing device of the consumer). Input analyzer 124 can determine the vehicle characteristics that are of interest to the user by analyzing the user inputs from a current browsing session and previous browsing sessions. The inputs analyzed may include, but are not limited to keystrokes, mouse movements, user interface gestures, user device movements, device location information, browser selections/operations, user voice commands, and eye-gaze measurements, among others. Analysis may be performed on user inputs received in “real-time”, or on those that have been logged in, for instance, profile database 110 and/or cookies stored in the web browser of computing device 130.

After determining vehicle characteristics of interest, related information is communicated throughout system 100. Specifically, browser interface 122 communicates with profile database 110. Stored on profile database 110 is information corresponding to user profiles related to potential vehicle buyers and vehicle profiles related to vehicles available for purchase at a particular dealership or one within a specified radius. For instance, user information may be stored in the user profile and vehicle characteristics of interest to the potential buyer may be stored in the vehicle profile. In some embodiments, at least a portion of the information found in the user/vehicle profiles stored on profile database 110 may be replaced with or supplemented by cookies/session IDs already stored on the web browser of computing device 130 corresponding to browser interface 122.

Based on the vehicle characteristics that have been determined to be of interest to the user, phrase selection engine 126 may present automated phrases corresponding to those vehicle characteristics to the user. For instance, responsive to indicating interest in an EV, phrase selection engine 126 may present to the user information related to charging stations and charge sharing services within the 50-mile radius specified by the user in the user/vehicle profile. The phrase selected may be presented to the user on the web browser of computing device 130, via browser interface 122, in the form of a clickable link, a chatbot, or other interactable object. According to the present disclosure, the determination as to which vehicle characteristics are of interest to the user may be made by an artificial intelligence agent as described above.

The artificial intelligence agent may be further configured to present the automated phrase to the user responsive to performing an algorithmic comparison of the browsing history, browsing actions, etc. Phrases presented by phrase selection engine 126 may be designed to elicit a further user interaction from the user, and distributive algorithms may be used to identify the phrase having the highest probability of eliciting the further user interaction.

In addition to and/or instead of eliciting a further interaction from the user, phrases presented by phrase selection engine 126 may explain dealer practices (e.g., based on user reviews, the dealership has a history of negotiating prices with prospective buyers), financing options for the vehicle of interest (e.g., the user is pre-approved for an auto loan at a first institution but not at a second institution), or a preferred package for the vehicle of interest (e.g., a performance package or an all-weather package). Phrase selection engine 126 may also provide information regarding any pre-approved loan packages for the user for the vehicle of interest, trade-in options (e.g., estimates of $10,000 for a trade-in at a first dealership, but $11,500 at a second dealership), pricing options (e.g., the vehicle of interest is available at one dealership for $49,500, while $48,900 at another), or alternate vehicle dealerships (e.g., the vehicle of interest is not available at the user's preferred dealership, but it is available elsewhere within a radius specified by the user).

These are merely examples of interactive phrases that may be presented to the user and others will be readily apparent to one of skill in the relevant arts. Also, the concepts described herein are applicable to any product or service not just vehicles.

In order to interact with the potential vehicle buyer, a chatbot can be displayed that applies the output from phrase selection engine 126 to engage in a focused dialogue. The phrase selection engine 126 is trained to provide phrase that would be the most well-received by the potential vehicle buyer. For example, if a customer browsing for cars, the output of the phrase selection engine 126 will be used to pinpoint when the user begins to feel confused (e.g., by using real-time biometric information); a chatbot can then be displayed to offer its expertise. The data being analyzed by input analyzer 124 can also be provided in real-time to sales representative that is in the background of the chatbot.

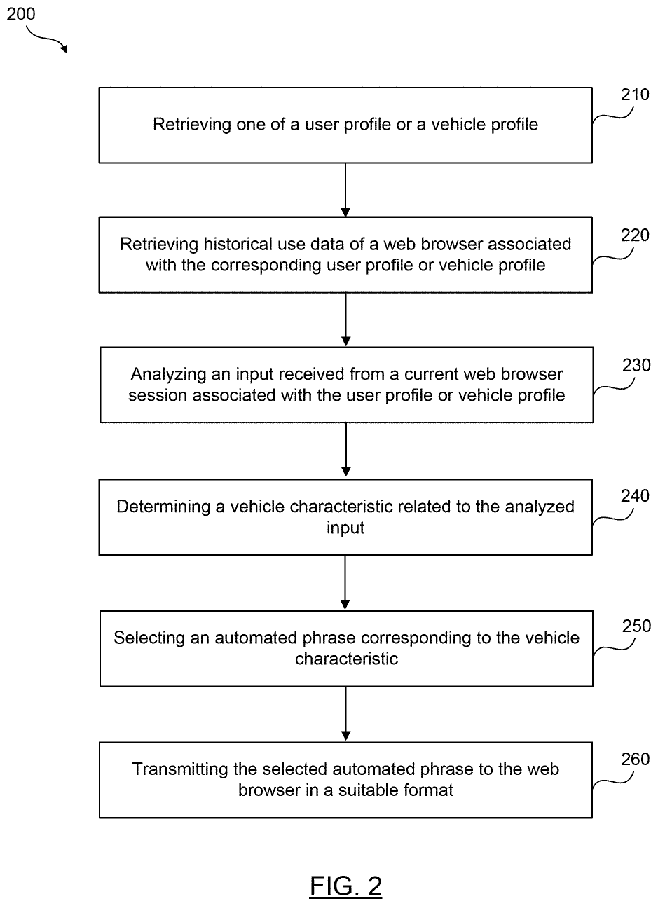

FIG. 2 is a flowchart of a method 200 of enhancing a web browsing session. According to the present disclosure, method 200 may be implemented by a system substantially similar or identical to system 100 and/or by execution of instructions embodied on a non-transitory computer-readable storage medium.

At step 210, a user profile and/or a vehicle profile is retrieved. The user profile may contain information related to a potential vehicle buyer, and the vehicle profile may include information related to a vehicle of interest to the user. As discussed above, the user's personal information may be stored in the user profile while vehicle characteristics (e.g., a vehicle make/model/year, trim level, mileage, cost, and so on) may be included in the vehicle profile.

At step 220, historical use data of a web browser associated with the corresponding user profile or vehicle profile is retrieved. It is noted that vehicles is just one example and other commercial products are contemplated as would be known to a person of ordinary skill in the art. Retrieving the historical use data may include retrieving browser cookies, the cookies storing browser history and the user profile or the vehicle profile. Cookies may be stored on the browser being used during the current browser session. The user profile and/or the vehicle profile may be stored on a database such as profile database 110. Stored in the cookies, the user profile, and the vehicle profile may be personal information of the user, vehicle characteristics that are of interest to the user, or other information related to the browsing history of the user.

At step 230, an input received from a current browser session associated with the user profile or vehicle profile is analyzed. Inputs analyzed at step 210 may include one or more of a keystroke, mouse movement/input, a user interface gesture, a user device movement, device location information, a browser selection, a browser operation, a user voice command, an eye-gaze measurement, or a biometric measurement. For instance, selection of an option from a drop-down menu, a string of text entered into a field of information, or words spoken by the user during the current browser session may be analyzed.

At step 240, a vehicle characteristic related to the analyzed input is determined. Artificial intelligence may be used to both analyze the input(s) and to determine the related vehicle characteristics. At step 250, an automated phrase corresponding to the vehicle characteristic can be selected. In many embodiments, the automated phrase corresponding to the vehicle characteristic is selected based on one or more vehicle characteristics determined in step 240. Further, the automated phrase is selected to elicit further user interaction during the current web browser session. At a step 260, the selected automated phrase is transmitted to the web browser in a format suitable for display or other format suitable for a user (e.g., an audio message).

In many embodiments, the automated phrase selected at step 250 may be transmitted for presentation in the current web browsing session. According to the present disclosure, the selected automated phrase may be presented/displayed by a web browser (e.g., the web browser on computing device 130) via a web interface (e.g., web interface 122). Further, selecting the automated phrase may include an artificial intelligence agent performing an algorithmic comparison of previous searches, browsing actions, and purchase history to identify a phrase having a highest probability of eliciting a further user interaction. In some examples, the algorithmic comparison may use a distributive algorithm to identify the phrase having the highest probability of eliciting the further user interaction. As an example, the phrase selected can be a phrase previously presented to users who have completed the highest percentage of final transactions (i.e., completed sales).

Selecting the automated phrase at step 250 may also include selecting a phrase offering to provide additional information about the vehicle characteristic(s) that are of interest to the user, a phrase providing additional information about the vehicle characteristic(s), and/or a phrase requesting additional information from the user related to the vehicle characteristic. Selecting the automated phrase may further include selecting a phrase further explaining dealer practices, financing options for the vehicle of interest, a preferred loan package for the vehicle of interest, a prequalified loan package for the vehicle interest, fees, trade-in options, pricing options, vehicle comparisons, alternate vehicles, or alternate vehicle dealerships.

In many embodiments, in addition to revealing the user's interest in buying a car, analysis of cookies or browsing/search history may indicate to the artificial intelligence agent other relevant information. For example, the user may be planning a move from a warm, temperate climate to a cold, snowy climate. In this scenario, after retrieving user and vehicle profile information at step 210 and historical use data of a web browser at step 220, inputs received from a current web browser session associated with the user/vehicle profile can be analyzed at step 230. At step 240, the artificial intelligence agent may determine a move is likely to occur in a specified time period. For instance, the artificial intelligence agent may determine the move is likely to occur within one month responsive to analyzing cookie information indicating the user booked a moving company within that timeframe.

Responsive to determining the move to the cold climate is relevant to the vehicle purchase, the artificial intelligence agent may begin presenting phrases to the user recommending vehicles having 4-wheel drive (4WD) or all-wheel drive (AWD) as a vehicle characteristic. Further, phrases suggesting the inclusion of a package of additional features may also be presented to the user. For example, an all-weather package of additional features can frequently include heated seats, wiper/headlight/side mirror defrosters, along with other features to better accommodate climates having (colder) inclement weather.

In some embodiments, a non-transitory, computer-readable medium storing instructions that, when executed by one or more processors of a device, cause the one or more processors to perform a method of enhancing a web browsing session. The method executed by the non-transitory computer readable medium may be substantially similar/identical to the method 200. The method of enhancing the web browsing session may include retrieving one of a user profile containing information related to a potential vehicle buyer or a vehicle profile containing information related to a vehicle of interest. The user profile and/or vehicle profile may be retrieved from cloud-based computing infrastructure (e.g., a collection of computing clusters, databases, servers, etc. which may or may not be disparate).

The method of enhancing the browser session executed by the non-transitory computer-readable medium may further include retrieving historical use data of a web browser associated with the corresponding user profile or vehicle profile. In some examples, the historical use data may be retrieved from cookies and/or web browser session IDs. The method may also include analyzing an input received from a current web browser session associated with the user profile or vehicle profile. Artificial intelligence/machine learning algorithms may be used to perform the analysis. The method may further include determining a vehicle characteristic related to the analyzed input and selecting, based on the determined vehicle characteristic, an automated phrase corresponding to the vehicle characteristic. In many embodiments, the automated phrase is selected to elicit further user interaction.

The non-transitory computer-readable medium may also transmit the selected automated phrase for presentation in the current web browsing session. Further, retrieving the historical use data may include retrieving cookies storing browsing history and the user profile or the vehicle profile. Data retrieved from the cookies, the user profile, and/or the vehicle profile may be automatically populated into a corresponding field information. For instance, when the user is filling out an application for an auto loan, the user's first name, last name, home address, and any applicable identification numbers may be automatically populated into the corresponding fields of information included in the loan application. Alternatively, the user may have control over what information is populated into which fields of information (e.g., via a mouse operation).

The non-transitory computer-readable medium selecting an automated phrase may further include performing, by an artificial intelligence agent, an algorithmic comparison by a distributive algorithm. Previous searches, browsing actions, and purchase history may be compared to identify a phrase having a highest probability of eliciting a further user interaction. Selecting an automated phrase may also include selecting one of a phrase offering to provide additional information about the vehicle characteristic, a phrase providing additional information about the vehicle characteristic, or a phrase requesting additional information from the user related to the vehicle characteristic. According to the present disclosure, the additional information may explain dealer practices, financing options for the vehicle of interest, a preferred loan package for the vehicle of interest, a prequalified loan package for the vehicle of interest, fees, trade-in options, pricing options, vehicle comparisons, alternate vehicles, or alternate vehicle dealerships.

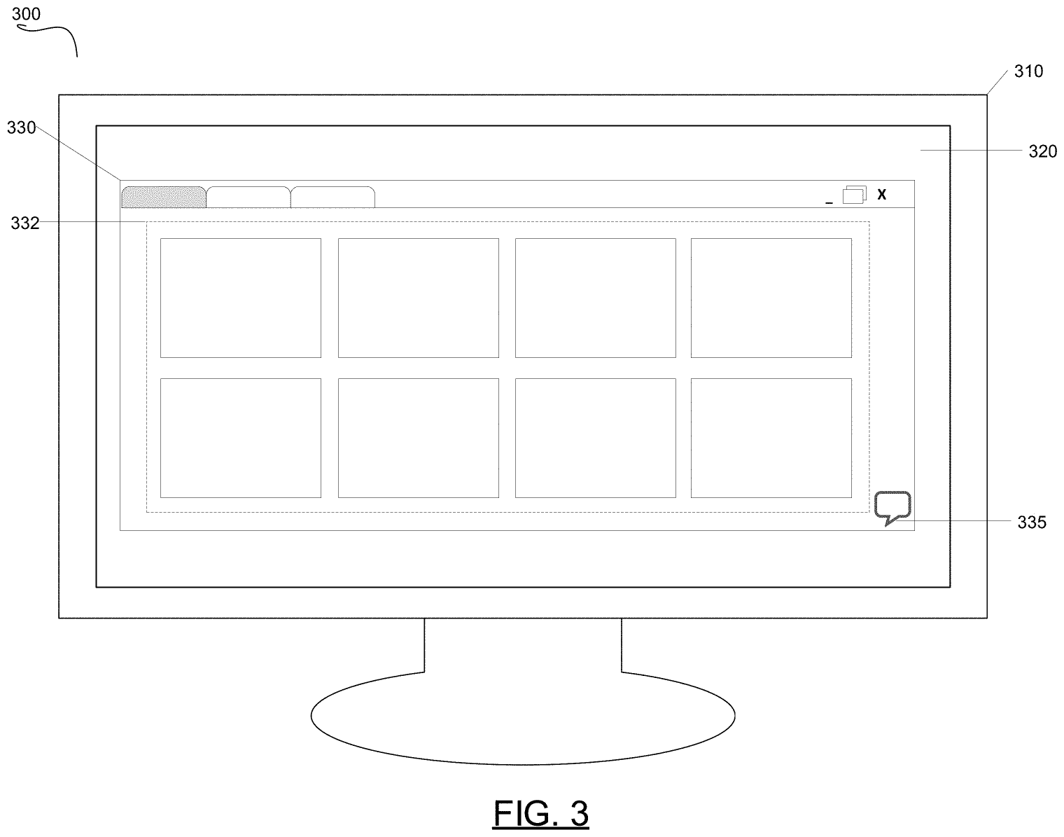

FIG. 3 is a representation of a (web) browsing interface 300. Via browsing interface 300, a user may engage using a web browsing window 330. While the user is engaging with web browsing window 330, a system (e.g., system 100), a method (e.g., method 200), or a non-transitory computer-readable storage medium executing a method substantially similar/identical to the method described above may be executing on or otherwise allowed by the infrastructure hosting the website being browsed in the web browsing session. The web browsing window 330 may be presented to the user on display region 320 (e.g., the screen) of a computing device 310. Computing device 310 may be one of a personal computing device, a laptop computer, a tablet or other mobile computing device, a personal digital assistant, etc.

Via a series of inputs such as a keystroke, a mouse movement, a click, a scrolling operation, a user touch/gesture input, a voice command, a device movement, and so on, the user may navigate through/interact with contents displayed on webpage 332 presented in web browsing window 330. Using algorithms, artificial intelligence running on infrastructure in communications with web interface 300 may analyze the browsing history, user inputs, or other browser interactions made by the user through web browsing window 330. Based on the interactions through web browsing window 330, the artificial intelligence agent can determine an automated phrase to present to the user. As illustrated in FIG. 3, the automated phrase may be presented to the user in the form of a chat bubble 335, although it is to be understood the automated phrase may be presented via any object with which the user may interact. Phrases presented to the user are determined to have the highest probability of eliciting further interaction from the user. As an example, the artificial intelligence agent may determine that questions related to a maximum monthly payment result in the highest number of completed transactions for the dealer.

For example, a user living in an urban setting who has researched electric vehicles may be presented, via browsing interface 300, automated phrases corresponding to charging stations within a certain radius from the home address of the user. An artificial intelligence agent executing a distributive algorithm may determine phrases to present which are related to charging stations within the radius, based on an analysis of the browsing history of the user. Through analyzing past interactions with different users considering an EV living in an urban environment, the artificial intelligence agent may determine information corresponding to charging stations has the highest probability of sustaining interaction by the user through web browsing window 330.

Different determinations may be made for a user interested in buying an EV living in a rural environment far removed from the nearest charging station. In this scenario, based on analysis of a combination of past user interactions, the browsing history of the user, and other users living in rural environments interested in buying EVs, the artificial intelligence agent can determine that presenting phrases corresponding to charging stations within a radius of the home address of the user (or the lack thereof) will cause the browsing session to be immediately terminated. However, the artificial intelligence may instead present phrases including information related to hybrid-combustion vehicles. The artificial intelligence agent can determine through the analysis of the past interactions of prospective EV buyers that these phrases are more likely to elicit further interaction by the user with the website. For example, the information included in the automated phrases may highlight some of the environmental benefits shared between EVs and hybrids and emphasize that hybrids are far less reliant upon charging stations than EVs.

While browsing window 330 depicted in FIG. 3 is shown on a personal computing device or a laptop extending/duplicating its display onto an external monitor. It should be understood that browsing window 330 discussed throughout the description of FIG. 3 may run on any type of computing device, as well as in any web browser (provided there is compatibility between device, operating system, and web browser as previously discussed above with respect to FIG. 1 and its accompanying description).

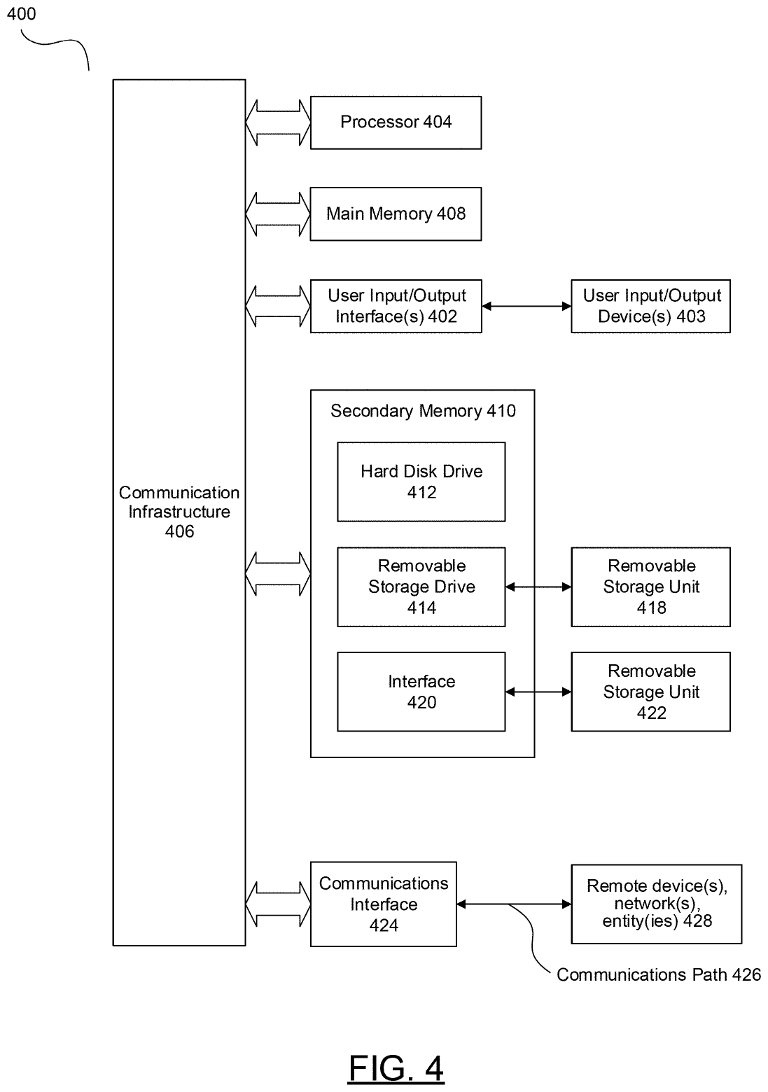

FIG. 4 depicts an example computer system useful for implementing various embodiments. Various embodiments may be implemented, for example, using one or more well-known computer systems, such as computer system 400 shown in FIG. 4. One or more computer systems 400 may be used, for example, to implement any of the embodiments discussed herein, as well as combinations and sub-combinations thereof.

Computer system 400 may include one or more processors (also called central processing units, or CPUs), such as a processor 404. Processor 404 may be connected to a communication infrastructure or bus 406.

Computer system 400 may also include user input/output device(s) 403, such as monitors, keyboards, pointing devices, etc., which may communicate with communication infrastructure 406 through user input/output interface(s) 402.

One or more of processors 404 may be a graphics processing unit (GPU). In many embodiments, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 400 may also include a main or primary memory 408, such as random access memory (RAM). Main memory 408 may include one or more levels of cache. Main memory 408 may have stored therein control logic (i.e., computer software) and/or data. Computer system 400 may also include one or more secondary storage devices or memory 410. Secondary memory 410 may include, for example, a hard disk drive 412 and/or a removable storage device or drive 414. Removable storage drive 414 may be a floppy disk drive, a magnetic tape drive, a compact disk drive, an optical storage device, tape backup device, and/or any other storage device/drive.

Removable storage drive 414 may interact with a removable storage unit 418. Removable storage unit 418 may include a computer usable or readable storage device having stored thereon computer software (control logic) and/or data. Removable storage unit 418 may be a floppy disk, magnetic tape, compact disk, DVD, optical storage disk, and/any other computer data storage device. Removable storage drive 414 may read from and/or write to removable storage unit 418.

Secondary memory 410 may include other means, devices, components, instrumentalities or other approaches for allowing computer programs and/or other instructions and/or data to be accessed by computer system 400. Such means, devices, components, instrumentalities or other approaches may include, for example, a removable storage unit 422 and an interface 420. Examples of the removable storage unit 422 and the interface 420 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 400 may further include a communication or network interface 424. Communication interface 424 may allow computer system 400 to communicate and interact with any combination of external devices, external networks, external entities, etc. (individually and collectively referenced by reference number 428). For example, communication interface 424 may allow computer system 400 to communicate with external or remote devices 428 over communications path 426, which may be wired and/or wireless (or a combination thereof), and which may include any combination of LANs, WANs, the Internet, etc. Control logic and/or data may be transmitted to and from computer system 400 via communication path 426.

Computer system 400 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 400 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 400 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 400, main memory 408, secondary memory 410, and removable storage units 418 and 422, as well as tangible articles of manufacture embodying any combination of the foregoing. Such control logic, when executed by one or more data processing devices (such as computer system 400), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 4. In particular, embodiments can operate with software, hardware, and/or operating system implementations other than those described herein.

It is to be appreciated that the Detailed Description section, and not the Abstract section, is intended to be used to interpret the claims. The Abstract section may set forth one or more but not all exemplary embodiments of the present application as contemplated by the inventor(s), and thus, are not intended to limit the present application and the appended claims in any way.

The present application has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the application that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present application should not be limited by any of the above-described exemplary embodiments, but should be defined only in accordance with the following claims and their equivalents.

1. A method of enhancing a web browsing session, the method comprising:
retrieving a user profile containing information related to a potential vehicle buyer containing information related to a purchase of a vehicle of interest;
retrieving historical use data of a web browser associated with the corresponding user profile;
analyzing an input received from a current web browser session, wherein the input is associated with the user profile;
determining a vehicle characteristic related to the input;
identifying a plurality of phrases provided to a plurality of other users, wherein at least a first subset of the plurality of users completed vehicle sales after a selection of a first phrase of the plurality of phrases, and wherein a second subset of the plurality of users completed vehicle sales after a selection of a second phrase of the plurality of phrases; and
selecting, based on the vehicle characteristic, the first phrase or the second phrase based whether the first subset or the second subset is larger, wherein the selected first phrase or second phrase is selected to elicit further user interaction during the current web browser session.

2. The method of claim 1 further comprising transmitting the selected automated phrase for presentation in the current web browsing session.

3. The method of claim 1, wherein retrieving the historical use data includes retrieving browser cookies storing browsing history and the user profile or the vehicle profile.

4. The method of claim 1, wherein selecting the automated phrase comprises performing, by an artificial intelligence agent, an algorithmic comparison of previous searches, browsing actions, and purchase history to identify a phrase having a highest probability of eliciting a further user interaction.

5. The method of claim 4, wherein the algorithmic comparison uses a distributive algorithm to identify the phrase having a highest probability of eliciting further user interaction.

6. The method of claim 5, wherein selecting the automated phrase comprises selecting one of a phrase offering to provide additional information about the vehicle characteristic, a phrase providing additional information about the vehicle characteristic, or a phrase requesting additional information from the user related to the vehicle characteristic.

7. The method of claim 6, wherein selecting the automated phrase comprises selecting a phrase further explaining dealer practices, financing options for the vehicle of interest, a preferred loan package for the vehicle of interest, a prequalified loan package for the vehicle of interest, fees, trade-in options, pricing options, vehicle comparisons, alternate vehicles, or alternate vehicle dealerships.

8. The method of claim 1, wherein analyzing the input comprises analyzing one or more of a keystroke, a mouse movement, a user interface gesture, a user device movement, device location information, a browser selection, a browser operation, a user voice command, an eye-gaze measurement, or a biometric measurement.

9. A system for presenting interactive phrases in a web browsing session, the system comprising:
a profile database configured to store user profiles related to potential vehicle buyers and vehicle profiles related to vehicles available for purchase; and
one or more processors configured to execute a set of computer-executable instructions stored on a memory, that when executed include:
a browser interface configured to communicate with the profile database, send at least portions of the vehicle profiles to a web browser, and receive inputs associated with respective user profiles;
an input analyzer configured to receive the inputs from the browser interface and determine vehicle characteristic related to the inputs; and
a phrase selection engine configured to:
identify a plurality of phrases provided to a plurality of other users, wherein at least a first subset of the plurality of users completed vehicle sales after a selection of a first phrase of the plurality of phrases, and wherein a second subset of the plurality of users completed vehicle sales after a selection of a second phrase of the plurality of phrases; and
select, based on the vehicle characteristic, the first phrase or the second phrase based whether the first subset or the second subset is larger automated phrase corresponding to the vehicle characteristic, wherein the selected first phrase or second automated phrase is selected to elicit further user interaction during the current web browser session.

10. The system of claim 9, wherein the phrase selection engine is an artificial intelligence agent configured to select an automated phrase by performing an algorithmic comparison of previous searches, browsing actions, and purchase history to identify a phrase having a highest probability of eliciting further user interaction.

11. The system of claim 10, wherein the phrase selection engine is configured to use a distributive algorithm to identify the phrase having the highest probability of eliciting further user interaction.

12. The system of claim 11, wherein the phrase selection engine is configured to select one of a phrase offering to provide additional information about the vehicle characteristic, a phrase providing additional information about the vehicle characteristic, or a phrase requesting additional information from a user related to the vehicle characteristic.

13. The system of claim 9, wherein the input analyzer is configured analyze one or more of a keystroke, a mouse movement, a user interface gesture, a user device movement, device location information, a browser selection, a browser operation, a user voice command, an eye-gaze measurement, or a biometric measurement.

14. The system of claim 9, wherein the phrase selection engine is configured to select a phrase further explaining dealer practices, financing options for the vehicle of interest, a preferred loan package for the vehicle of interest, a prequalified loan package for the vehicle of interest, fees, trade-in options, pricing options, vehicle comparisons, alternate vehicles, or alternate vehicle dealerships.

15. A non-transitory computer-readable medium storing instructions that when executed by one or more processors of a device cause the one or more processors to perform a method of enhancing a web browsing session comprising:
retrieving one of a user profile containing information related to a potential vehicle buyer containing information related to a purchase of a vehicle of interest;
retrieving historical use data of a web browser associated with the corresponding user profile;
analyzing an input received from a current web browser session, wherein the input is associated with the historical use data and the user profile;
determining a vehicle characteristic related to the input;
identifying a plurality of phrases provided to a plurality of other users, wherein at least a first subset of the plurality of users completed vehicle sales after a selection of a first phrase of the plurality of phrases, and wherein a second subset of the plurality of users completed vehicle sales after a selection of a second phrase of the plurality of phrases; and
selecting, based on the vehicle characteristic, the first phrase or the second phrase based whether the first subset or the second subset is larger, wherein the selected first phrase or second phrase is selected to elicit further user interaction during the current web browser session.

16. The non-transitory computer-readable medium of claim 15 further comprising transmitting the selected automated phrase for presentation in the current web browsing session.

17. The non-transitory computer-readable medium of claim 15, wherein retrieving the historical use data includes retrieving browser cookies storing browsing history and the user profile or the vehicle profile.

18. The non-transitory computer-readable medium of claim 15, wherein selecting the automated phrase comprises performing, by an artificial intelligence agent, an algorithmic comparison by a distributive algorithm of previous searches, browsing actions, and purchase history to identify a phrase having a highest probability of eliciting further user interaction.

19. The non-transitory computer-readable medium of claim 15, wherein analyzing the input comprises analyzing one or more of a keystroke, a mouse movement, a user interface gesture, a user device movement, device location information, a browser selection, a browser operation, a user voice command, an eye-gaze measurement, or a biometric measurement.

20. The non-transitory computer-readable medium of claim 15, wherein selecting the automated phrase comprises selecting one of a phrase offering to provide additional information about the vehicle characteristic, a phrase providing additional information about the vehicle characteristic, or a phrase requesting additional information from the user related to the vehicle characteristic,
wherein the additional information explains dealer practices, financing options for the vehicle of interest, a preferred loan package for the vehicle of interest, a prequalified loan package for the vehicle of interest, fees, trade-in options, pricing options, vehicle comparisons, alternate vehicles, or alternate vehicle dealerships.

21. The method of claim 1, further comprising:
determining that a user is confused, during the current web browsing session, based on biometric information; and
responsive to the determination that the user is confused based on the biometric information, displaying a chatbot during the current web browsing session, wherein the first phrase is displayed via the chatbot.
